(19) United States
(12) Patent Application Publication
(10) Pub. No.: US 2002/0149555 A1
(43) Pub. Date: Oct. 17, 2002

(54) TWO-DIMENSIONAL ACTIVE-MATRIX TYPE LIGHT MODULATION DEVICE AND TWO-DIMENSIONAL ACTIVE-MATRIX TYPE LIGHT-EMITTING DEVICE

(76) Inventor: KOICHI KIMURA, SHIZUOKA-KEN (JP)

Correspondence Address: SUGHRUE MION ZINN MACPEAK AND SEAS, 2100 PENNSYLVANIA AVENUE NW, WASHINGTON, DC, 200373202

(21) Appl. No.: 09/161,699

(22) Filed: Sep. 29, 1998

(30) Foreign Application Priority Data
Sep. 29, 1997 (JP) 264481/1997

(51) Int. Cl. G09G 3/36

(52) U.S. Cl. 345/97

(57) ABSTRACT

In a pixel circuit constituting one pixel of the two-dimensional matrix light modulation device consisting of a plurality of pixels, a drive circuit (DR) for driving a light modulating layer (PM) is constituted by a ferroelectric gate PET (Tr). The pixel electrode (1) in each pixel circuit is connected to the drain of the ferroelectric gate PET (Tr), and voltage (V_{com}) is applied to a counter electrode (2). The source electrodes and substrate electrodes of the matrix light modulation device of the same column are connected together, and a data signal (V_{b}) is input in a column unit. Likewise, the gate electrodes of the same row are connected together, and a row selecting signal (V_{g}) is input in a row unit.

### FIELD OF THE INVENTION

The present invention relates to liquid crystals, digital mirror devices (DMDs), and light address type space light modulation devices that are employed in displays, such as flat displays and video projectors, or in exposure systems, and also relates to two-dimensional active-matrix type light-emitting devices, such as thin-film ELs, organic ELs, light-emitting diodes (LEDs), and field emission displays (FEDs).

### DESCRIPTION OF THE RELATED ART

Conventionally, two-dimensional matrix type light modulation and light emitting devices, such as liquid crystals, DMDs, thin-film ELs, organic ELs, LEDs, and FEDs, have been employed to constitute the above-mentioned flat displays. etc.

The two-dimensional matrix type light modulation device Is basically equipped with a plurality of pixel electrodes arranged in the form of a two-dimensional matrix consisting of rows and columns, a counter electrode arranged with a space with these pixel electrodes, and a light modulating layer which modulates light incident thereon in accordance with an applied voltage between both of these electrodes. For light modulation devices, the active-matrix type which performs the writing of image data and the drive of various phonic devices independently of each other for each pixel by a semiconductor pixel circuit formed in the form of a matrix on a substrate is effective (this type of light modulation device will be particularly referred to as a “two-dimensional active-matrix type light modulation device”).

The two-dimensional matrix type light-emitting device is one in which the light modulating layer in the above-mentioned light modulation device is replaced with a light-emitting layer which emits light in accordance with current flowing therethrough between both electrodes.

The two-dimensional active-matrix type light modulation device will hereinafter be described in detail.

FIG. 1 shows an equivalent circuit of one pixel circuit in a basic two-dimensional active-matrix type light modulation device, a ferroelectric liquid crystal being employed in the light modulating layer. As shown here, the pixel circuit In the two-dimensional active-matrix type light-emitting device is equipped with a light modulating layer PM, which in turn modulates light in accordance with an applied voltage between a pixel electrode 1 and a counter electrode 2. A common electrode voltage V_{com} (which is common to all pixels) is applied to the counter electrode 2. The pixel electrode 1 is connected to the source (or drain) of a metal-oxide-semiconductor field-effect transistor (MOSFET). The drain (or source) is connected to a data signal (column selecting signal) line so that voltage V_{d} is applied to the drain (or source). On the other hand, the gate of the MOSFET is connected to a row selecting signal line so that voltage V_{g} is applied to the gate. Also, capacitor C1 is connected to the connecting point between the pixel electrode 1 and the MOSFET.

In the case where photosensitive material is exposed at high speed with a high-speed response two-dimensional active-matrix type light modulation device such as a ferroelectric liquid crystal, a conventional active circuit consisting of a MOSFET and a capacitor, such as that shown in FIG. 1, requires the charging time to obtain a necessary electric charge in writing data and the time to ensure the stable response of the liquid crystal, so that the data writing time will become long. For this reason, to write data in a short time, a memory circuit is generally used as an active-matrix circuit.

Conventional light modulation devices or light-emitting devices, such as liquid crystals (particularly, liquid crystals taking a finite stable state, such as ferroelectric liquid crystals), DMDS, thin-film ELs, and FEDs, have either a finite stable state or a sharp gradation characteristic, so that continuous gradation control is difficult. For this reason, in these two-dimensional active-matrix type light modulation devices, gradation control by time modulation is generally performed.

More specifically, gradation control such as that shown in FIG. 2 is performed. That is, binary data is written to all pixels for period T_{w}, and thereafter, display is performed for a constant time in accordance with the written data. Within one field, this sequence Is performed a plurality of times, and by varying display times, multi-gradation display can be performed. In this case, written data needs to be stored stably or data needs to be written at high speed. To achieve this end, generally memory circuits are often used as active-matrix circuits.

FIG. 3 illustrates an active circuit constituted with a memory circuit. In this constitution, a static random-access memory (SRAM) having a memory function is used as an active circuit, and binary data is written in. The writing time becomes equal to the time to access the SRAM circuit, so high-speed writing is possible. The output Vₒᵤₜ is a stable binary potential, and by the voltage applied to the light modulating layer PM, light incident thereon can be modulated.

However, a SRAM circuit such as that shown in FIG. 3 usually requires 6 to 8 MOSFETs. Therefore, if such SRAMs are used in the active circuit of a high-fine two-dimensional active-matrix type circuit exceeding a few hundreds of thousands of pixels to a million pixels, then the device area will become large and the cost will become high. Also, in the case the pixel size is desired to be made smaller, the number of transistors is large and therefore there is a limit.

### SUMMARY OF THE INVENTION

The present invention has been made in view of the aforementioned problems. Accordingly, it is an object of the present invention to provide two-dimensional active-matrix type light modulation and light-emitting devices that have a memory function and render high-speed writing possible, by a constitution with a few number of transistors per pixel.

The two-dimensional active-matrix type light modulation and light-emitting devices according to the present invention use a ferroelectric gate FET as a two-dimensional active-matrix circuit, and have a memory function with one or two transistors per pixel and make high-speed writing possible, particularly by a basic constitution for writing image data at high speed in order of a row and an addressing method.

That is, the two-dimensional active-matrix type light modulation device according to the present invention comprises: a plurality of pixel electrodes arranged in the form of a two-dimensional matrix consisting of rows and columns; a plurality of counter electrodes; a plurality of light modulating layers, each light modulating layer being interposed between the pixel electrode and the counter electrode for modulating light incident thereon in accordance with an applied voltage between the pixel electrode and the counter electrode; and a drive circuit constituted by ferroelectric gate field-effect transistors respectively connected to the pixel electrodes.

In such a two-dimensional active-matrix type light modulation device, it is preferable that the drive circuit write data to the ferroelectric gate field-effect transistors in order of a row.

Also, the drive circuit may write data to all of the pixels and then may apply a voltage for driving the light modulating layer between the counter electrode and the pixel electrode in common for all. pixels.

In addition, the drive circuit may change a ferroelectric gate or the ferroelectric gate field-effect transistor to a first polarization state and then may write data in accordance with input of data so that the first polarization state is changed to a second polarization state or so that the first polarization state is held.

Furthermore, the drive circuit may perform row selection with a gate electrode of the ferroelectric gate field-effect transistor and may write data with a source electrode and drain electrode of the ferroelectric gate field-effect transistor and a substrate electrode or back-surface electrode of the ferroelectric gate field-effect transistor.

Moreover, the drive circuit may perform modulation by binary static drive.

On the other hand, the two-dimensional active-matrix type light-emitting device according to the present invention comprises; a plurality of pixel electrodes arranged in the form of a two-dimensional matrix consisting of rows and columns; a plurality of counter electrodes; a plurality of light-emitting layers, each light-emitting layer being interposed between the pixel electrode and the counter electrode for emitting light in accordance with current flowing through the light-emitting layer between the pixel electrode and the counter electrode; and a drive circuit constituted by ferroelectric gate field-effect transistors respectively connected to the pixel electrodes.

In such a two-dimensional active-matrix type light-emitting device, it is preferable that the drive circuit write data to the ferroelectric gate field-effect transistors in order of a row.

Also, in the two-dimensional active-matrix type light-emitting device, the drive circuit may write data to all of the pixels and then may allow a current for driving the light-emitting layer to pass through the counter electrode and the pixel electrode in common for all pixels.

In addition, in the two-dimensional active-matrix type light-emitting device, the drive circuit may change a ferroelectric gate of the ferroelectric gate field-effect transistor to a first polarization state and then may write data in accordance with input of data so that the first polarization state is changed to a second polarization state or so that the first polarization state is held.

Furthermore, in the two-dimensional active-matrix type light-emitting device, the drive circuit may perform row selection with a gate electrode of the ferroelectric gate field-effect transistor and may write data with a source electrode and drain electrode of the ferroelectric gate field-effect transistor and a substrate electrode or back-surface electrode of the ferroelectric gate field-effect transistor.

The aforementioned ferroelectric field-effect transistor (FET) is a FET in which a ferroelectric substance such as PZT (Pb(Zr,Ti)O₃) is formed between the gate electrode and semiconductor of a conventional metal-insulator-semiconductor field-effect transistor (MISFET), and high-speed access (up to 100 ns) is possible. A non-volatile random access memory (RAM) can be constituted with a single FET per bit. This ferroelectric gate FET is classified into several types, depending on the gate structure. As the representative type, there are a ferroelectric gate FET with metal-ferroelectric-semiconductor (MSF) structure and a ferroelectric gate FET with metal-ferroelectric-metal-insulator-semiconductor (MFMIS) structure (see NAKAJIMA et al.,1995 IEEE Int.. Solid-State Circuits Conf., Digest of Technical Papers, pp. 68-69 (1995)).

The two-dimensional active-matrix type light modulation and light-emitting devices according to the present invention are constituted by using a ferroelectric gate FET having a memory function as a two-dimensional active-matrix circuit, and a single ferroelectric gate FET can function as memory. Therefore, the number of transistors can be reduced as compared with conventional light modulation and light-emitting devices using 6 to 8 transistors. In addition, since image data can be written at high speed in order of a row, it becomes possible to constitute two-dimensional active-matrix type light modulation and light-emitting devices that can perform high-speed writing.

### BRIEF DESCRIPTION OF THE DRAWINGS

The present invention will be described in further detail with reference to the accompanying drawings wherein:

FIG. 1 is a circuit diagram showing an equivalent circuit of one pixel circuit in a basic two-dimensional active-matrix type light modulation device;

FIG. 2 is a diagram used to explain the gradation control of the two-dimensional active-matrix type light modulation device;

FIG. 3 Is a circuit diagram showing an active circuit employing a SRAM;

FIGS. 4(A) and 4(B) are diagrams showing a ferroelectric gate FET;

FIGS. 5(A), 5(B), and 5(C) are diagrams used to explain the polarization direction of the ferroelectric gate FET;

FIG. 6 is a diagram used to explain the basic characteristic of the ferroelectric gate FET;

FIG. 7 is an equivalent circuit diagram of a portion of the two-dimensional active-matrix type light modulation device of the present invention in which one ferroelectric gate FET is employed in each pixel circuit;

FIG. 8 is a diagram used to explain the OFF polarization state of the ferroelectric gate FET of the above-mentioned light modulation device;

FIG. 9 is a diagram used to explain a polarization state obtained when, in a pixel connected to a selected row, the data line is on;

FIG. 10 is a diagram used to explain a polarization state obtained when, in a pixel connected to a selected row, the data line is off;

FIG. 11 is a diagram used to explain a polarization state obtained when, in a pixel connected to a non-selected row, the data line is on;

FIG. 12 is a diagram used to explain a polarization state obtained when, in a pixel connected to a non-selected row, the data line is off;

FIG. 13 is a circuit diagram of a 2×2 matrix used to explain a data writing method;

FIG. 14 is a voltage waveform diagram of the FET of the above-mentioned matrix circuit;

FIGS. 15(A), 15(B), and 15(C) are equivalent circuit diagrams used to explain the switching operation of the ferroelectric gate FET:

FIG. 16 is a diagram showing the drive circuit of the equivalent circuit in FIG. 15 equipped with constant current drive;

FIG. 17 is a diagram showing the drive circuit of the equivalent circuit in FIG. 15 equipped with an AC voltage source;

FIG. 18 is an equivalent circuit diagram of a pixel circuit in which a substrate electrode is connected to a data signal line;

FIG. 19 is an equivalent circuit diagram of a portion of the two-dimensional active-matrix type light modulation device of the present invention in which two ferroelectric gate FETs are employed in each pixel circuit;

FIGS. 20(A) and 20(B) are diagrams used to explain the polarization state of the ferroelectric gate FET of the above-mentioned light modulation device that is obtained during data writing; and

FIGS. 21(A), 21(B), and 20(C) are diagrams used to explain the drive method of the light modulating layer of the above-mentioned light modulation device.

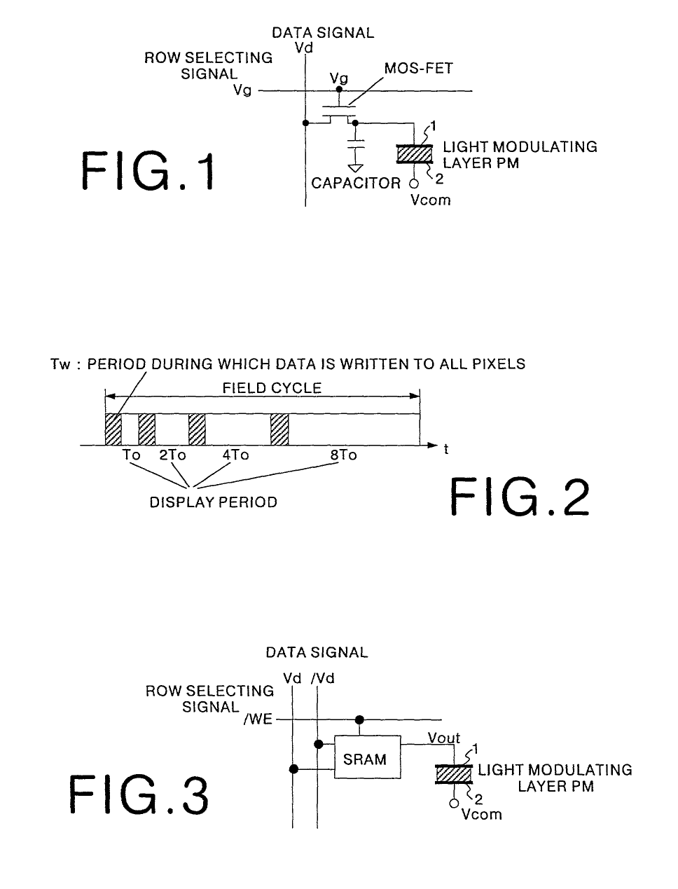

### DETAILED DESCRIPTION OF THE PREFERRED EMBODIMENTS

Embodiments of two-dimensional active-matrix type light modulation and light-emitting devices according to the present invention will hereinafter be described in detail in reference to the drawings.

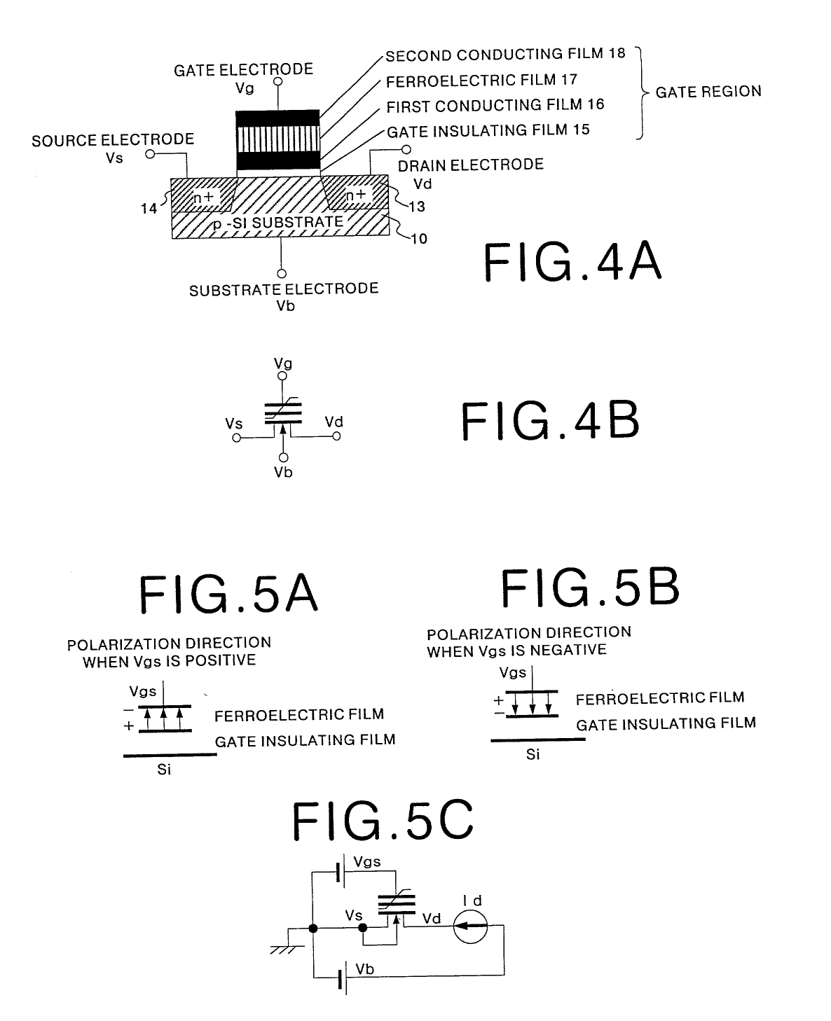

Initially, a ferroelectric gate FET employed in the present invention will be described briefly in reference to FIGS. 4 through 6.

FIG. 4(A) shows a ferroelectric gate FET with n-channel MFMIS structure. As shown, an n-channel MOSFET is formed on a p⁻-type monocrystalline silicon semiconductor substrate 10. The n-channel MOSFET Is constituted by an n⁺-type drain region 13, an n⁺-type source region 14, a gate insulating film 15, a first conducting film 16, a ferroelectric film 17, and a second conducting film 18, stacked on the p⁻-type silicon semiconductor substrate 10 in the recited order. The drain region 13 is connected to a drain electrode 13a to which voltage V_{d} is applied. The source region 14 is connected to a source electrode 14a to which voltage Vₛ is applied. The second conducting film 18 is connected to a gate electrode 18a to which voltage V_{g} is applied. The p⁻-type silicon semiconductor substrate 10 is connected to a substrate electrode 10a to which voltage V_{b} is applied. FIG. 4(B) shows the circuit symbols of the ferroelectric gate FET shown in FIG. 4(A).

Note that the ferroelectric gate FET which is employed in the present invention is not limited to the aforementioned MFMIS structure but may have MFS structure or MFIS structure.

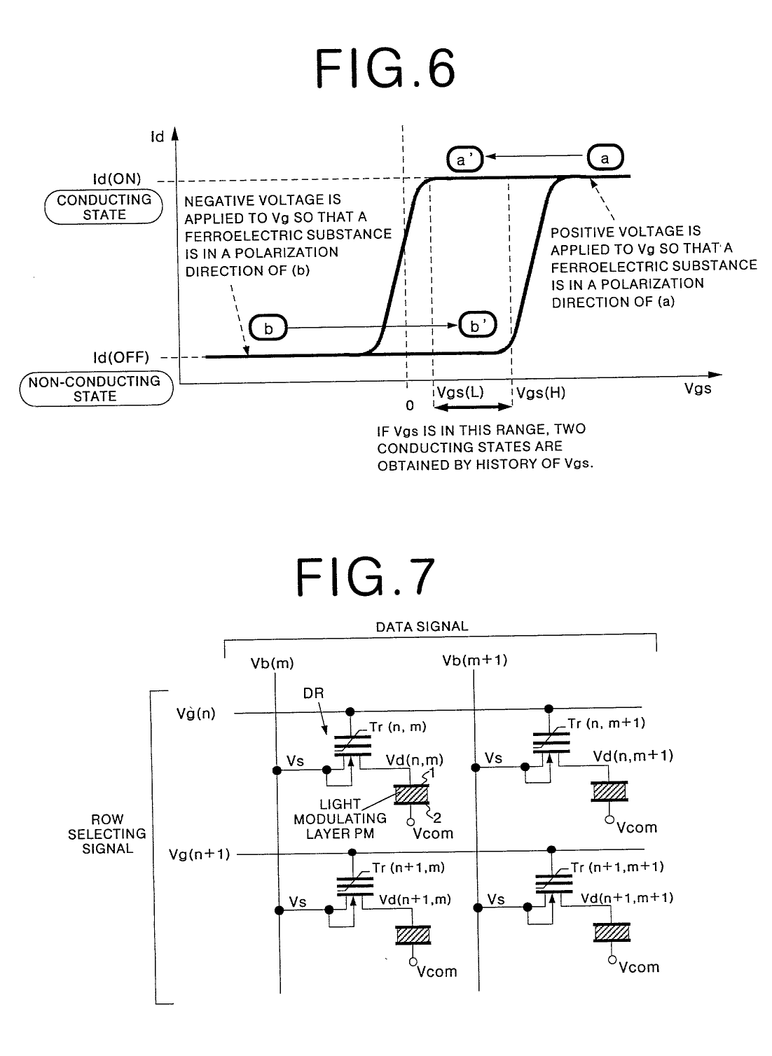

In reference to FIGS. 5 and 6, a description will hereinafter be made of the basic characteristics of the ferroelectric gate FET having the aforementioned MFMIS structure. FIG. 5(A) shows the polarization direction of the ferroelectric film 17 obtained when the voltage V_{gs} on the gate electrode of the FET with respect to the source electrode (gate-to-source voltage) is positive, while FIG. 5(B) shows the polarization direction of the ferroelectric film 17 obtained when the gate-to-source voltage V_{gs} is negative. FIG. 5(C) shows a circuit for measuring the electrical characteristics of the ferroelectric gate FET including voltages V_{d}, Vₛ, V_{g}, and V_{b} which are applied to the electrodes. In FIG. 5(C), reference character I_{d} denotes drain current. The I_{d}-V_{gs} characteristic of the ferroelectric gate FET shown in the equivalent circuit of FIG. 5(C) is shown in FIG. 6.

As clearly seen from FIG. 6, since the I_{d}-V_{gs} characteristic has a hysteresis characteristic, the polarization direction (polarity) of the ferroelectric film 17 can be varied by controlling the gate voltage V_{g}. With this, the threshold value of the gate voltage of the FET varies, and if the gate-to-source voltage V_{gs} is within a predetermined range, two conducting states can be obtained by the history of V_{gs}. Therefore, even if the gate-to-source voltage V_{gs} is the same, when a transition is made from (a) of FIG. 6 to (a′), a conducting state is formed between the drain and the source. On the other hand, when a transition is made from (b) of FIG. 6 to (b′), a non-conducting state is formed between the drain and the source. These states will be semipermanently stored as long as the polarization state is not varied. That is, in the ferroelectric gate FET, by controlling the polarization of the gate voltage, the spontaneous polarity of the ferroelectric layer is inverted and the threshold voltage of the FET varies. Therefore, in a certain gate voltage range, a conducting state or a non-conducting state is formed between the drain and the source, depending upon the polarization state of the ferroelectric substance. These states are semipermanently held. Thus, the ferroelectric gate FET functions as a memory transistor.

Next, a detailed description will be made of the two-dimensional matrix constitution and drive method of the two-dimensional active-matrix type light modulation and light-emitting devices of the present invention in which one ferroelectric gate FET is employed in each pixel circuit. FIG. 7 shows an equivalent circuit of a portion of the two-dimensional active-matrix type light modulation device according to the present invention. That is, FIG. 7 shows pixel circuits constituted by the mth column, (m+1)st column, nth row, and (n+1)st row of the two-dimensional matrix type light modulation device consisting of a plurality of pixels. The source electrodes and substrate electrodes of the same column of the pixel circuits each consisting of a ferroelectric gate FET (Tr) and a light modulating layer PM are connected together, and a data signal V_{b(m)} or V_{b(m+1)} is input in a column unit. Likewise, the gate electrodes of the same row are interconnected, and a row selecting signal V_{g(n)} or V_{g(n+1)} is input in a row unit. The pixel electrode 1 of each pixel is connected to the drain of the ferroelectric gate FET (Tr), and voltage V_{com} is applied to the counter electrode 2. A description will hereinafter be made of the drive method in this constitution.

The row selecting signal is connected to the gate electrodes of the ferroelectric gate FETs of the same row, and the row selection for writing is performed. Also, the data signal is connected to the source electrodes of the ferroelectric gate FETs of the same column, and the data (voltage) for varying the conducting state (conducting or non-conducting) of the ferroelectric gate FET in synchronization with the row selection is applied. In this manner, data writing is performed.

However, at this time, there is a need to apply the voltages of the row selecting signals and data signals so that the conducting states of the ferroelectric gate FETs of non-selected rows are not varied (or are held).

Here, if “ON” is written in, the polarization state of the ferroelectric layer of the FET will become the state shown in FIG. 5(A). Under a predetermined electrode condition, the state of the FET becomes a conducting state and the drain electrode voltage V_{d} becomes nearly equal to the source electrode voltage Vₛ. If, on the other hand, “OFF” is written in, the polarization state of the ferroelectric layer of the FET will become the state shown in FIG. 5(B). Under a predetermined electrode condition, the state of the FET becomes a non-conducting state.

Next, after data has been written in order of a row and written to all FETs, voltage enough to drive the light modulating layer PM is applied as source electrode voltage V_{d} and common electrode voltage V_{com}. If it is assumed that voltage Vₛ−V_{com} is Vₒₚ, the voltage V_{mod(ON)} on the light modulating layer connected to the FET in the ON state will be nearly Vₒₚ and therefore the light modulating layer PM will be caused to be in a modulating state. On the other hand, the voltage V_{mod(OFF)} on the light modulating layer PM connected to the FET In the OFF state becomes nearly zero and therefore the light modulating layer PM is caused to be in a non-modulating state. This is because if the capacity C_{mod} of the light modulating layer PM>>the parasitic capacity Cₛ of the source electrode, V_{mod(OFF)} will become zero.

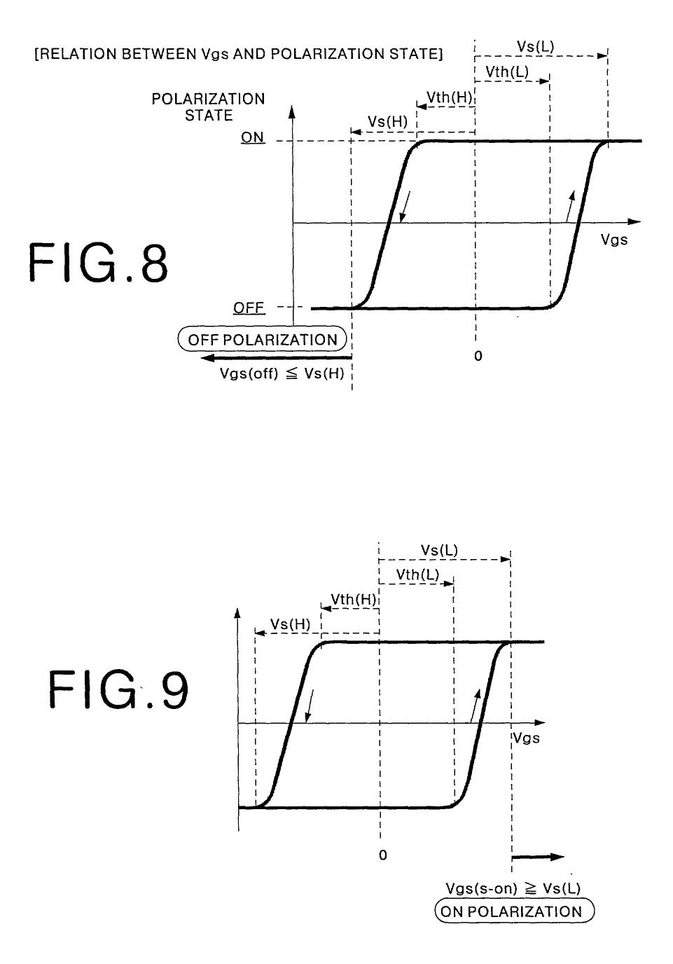

Next, a description will be made in further detail in reference to FIGS. 8 through 12 and Table 1.

Initially, the polarization state of the ferroelectric layer of the FET is caused to be in an OFF state. If the gate-to-source voltage V_{gs} in this OFF state is taken to be V_{gs(off)} and the gate-to-source voltage V_{gs} necessary for varying the polarization state from an ON state to an OFF state (e.g., OFF saturation voltage) is taken to be V_{s(H)}, when V_{gs(off)}≦V_{s(H)}, the polarization state always becomes an OFF state regardless of the previous state (see FIG. 8).

Next, selection is performed in order of a row, and data is written. In the pixel connected to the selected row, when the data line is on, the polarization state of the FET is caused to be in an ON state. If the gate-to-source voltage V_{gs} in this ON state is taken to be V_{gs(s-on)} and the gate-to-source voltage V_{gs} necessary for varying the polarization state from an OFF state to an ON state (e.g., ON saturation voltage) is taken to be V_{s(L)}, when V_{gs(s-on)}≧V_{s(L)}, the polarization state always becomes an ON state regardless of the previous state (see FIG. 9).

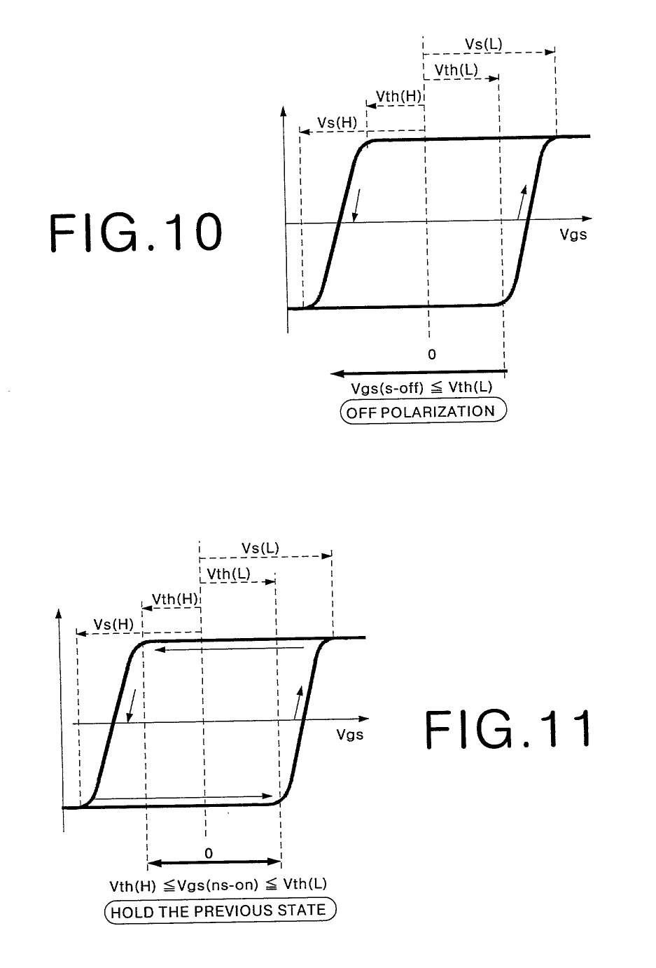

Also, in the pixel connected to the selected row, when the data line is off, the polarization state of the FET is held in an OFF state. If the gate-to-source voltage V_{gs} in this OFF state is taken to be V_{gs(s-off)} and the gate-to-source voltage V_{gs} immediately before an OFF state changes toward an ON state (e.g., ON threshold voltage) is taken to be V_{th(L)}, when V_{gs(s-off)}≦V_{th(L)}, the previous OFF state is held (see FIG. 10).

On the other hand, in a pixel connected to a non-selected row, when the data line is on, the polarization state of the FET is held. If the gate-to-source voltage V_{gs} in this state Is taken to be V_{gs(ns-on)} and the gate-to-source voltage V_{gs} immediately before an ON state changes toward an OFF state (e.g., OFF threshold voltage) is taken to be V_{th(H)}, when V_{th(H)}≦V_{gs(ns-on)}≦V_{th(L)}, the polarization state holds the previous state regardless of the previous state (see FIG. 11).

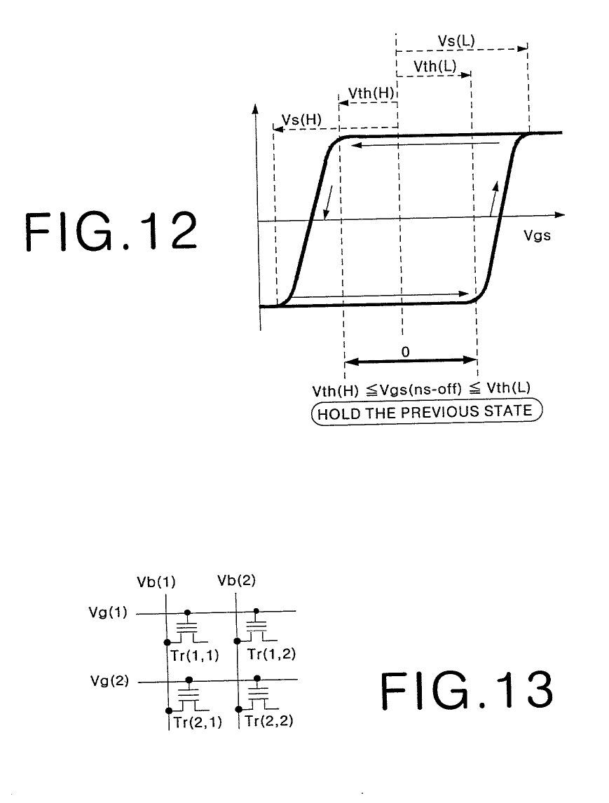

In a pixel connected to a non-selected row, when the data line is off, the polarization state of the FET is held. If V_{gs} in this state is taken to be V_{gs(ns-off)}, when V_{th(H)}≦V_{gs(ns-off)}≦V_{th(L)}, the polarization state holds the previous state regardless of the previous state (see FIG. 12).

The relation between row selecting signal voltage V_{g}, data signal voltages V_{b(on)} and V_{b(off)}, and V_{gs} (=V_{g}−V_{b}) is shown in Table 1.

TABLE 1
Data signal voltage Vb

| | ON | OFF |
|---|---|---|
| | Vb(on) | Vb(off) |
| | 0 | 0 |
| Vg | Vgs(r-on) ≦ Vs(H) | Vgs(r-off) ≦ Vs(H) |
| | Vs(L) | |
| 0 | 0 | 0 |
| OFF Vg(r) | Vs(H) | Vs(H) |
| writing | | |
| (reset) | | |
| | Vgs(s-on) ≦ Vs(L) | Vgs(s-off) ≦ Vth(L) |
| Vg(s) | Vs(L) | Vth(L) |
| Selection | | |
| 0 | 0 | 0 |
| | Vgs(ns-on) ≦ Vth(L) | Vgs(ns-off) ≦ Vth(H) |
| Non-selection | | |
| Vg(ns) | Vth(L) | |
| 0 | 0 | 0 |
| | | Vth(H) |

From the aforementioned voltage combinations and conditions, the following relational equations are obtained:

V_{gs(r-on)}=V_{g(r)}−V_{b(on)}≦V_{s(H)} (1)

V_{gs(r-on)}=V_{g(r)}−V_{b(off)}≦V_{s(H)} (2)

V_{gs(s-on)}=V_{g(s)}−V_{b(on)}≧V_{s(L)} (3)

V_{gs(s-off)}=V_{g(s)}−V_{b(off)}≦V_{th(L)} (4)

V_{gs(ns-on)}=V_{g(ns)}−V_{b(on)}≦V_{th(L)} (5)

V_{gs(ns-off)}=V_{g(ns)}−V_{b(off)}≧V_{th(H)} (6)

If V_{b(off)}−V_{b(on)}>0, from Eqs. (1) and (2)

V_{g(r)}−V_{b(on)}≦V_{s(H)} (7)

From Eqs. (3) and (4),

V_{b(off)}−V_{b(on)}≧V_{s(L)}−V_{th(L)} (8)

From Eqs. (5) and (6),

V_{b(off)}−V_{b(on)}≦V_{th(L)}−V_{th(H)} (9)

From Eqs. (3) and (5),

V_{g(s)}−V_{g(ns)}≧V_{s(L)}−V_{th(L)} (10)

From Eqs. (4) and (6),

V_{g(s)}−V_{g(ns)}≦V_{th(L)}−V_{th(H)} (11)

If V_{b(off-on)}=V_{b(off)}−V_{b(on)} and V_{g(s-on)}=V_{g(s)}−V_{g(ns)}, the following conditions will be obtained from Eqs. (8) and (9):

V_{s(L)}−V_{th(L)}≦V_{b(off-on)}≦V_{th(L)}−V_{th(H)} (12)

V_{s(L)}−V_{th(L)}≦V_{g(s-ns)}≦V_{th(L)}−V_{th(H)} (13)

From the aforementioned conditions, data writing in order of a row becomes possible under the following conditions.

(a) For OFF-writing (reset):

V_{g(r)}−V_{b(on)}≦V_{s(H)}

(b) For data writing in order of a row:

V_{s(L)}−V_{th(L)}≦V_{b(off-on)}≦V_{th(L)}−V_{th(H)}

V_{s(L)}−V_{th(L)}≦V_{g(s-on)}≦V_{th(L)}−V_{th(H)}

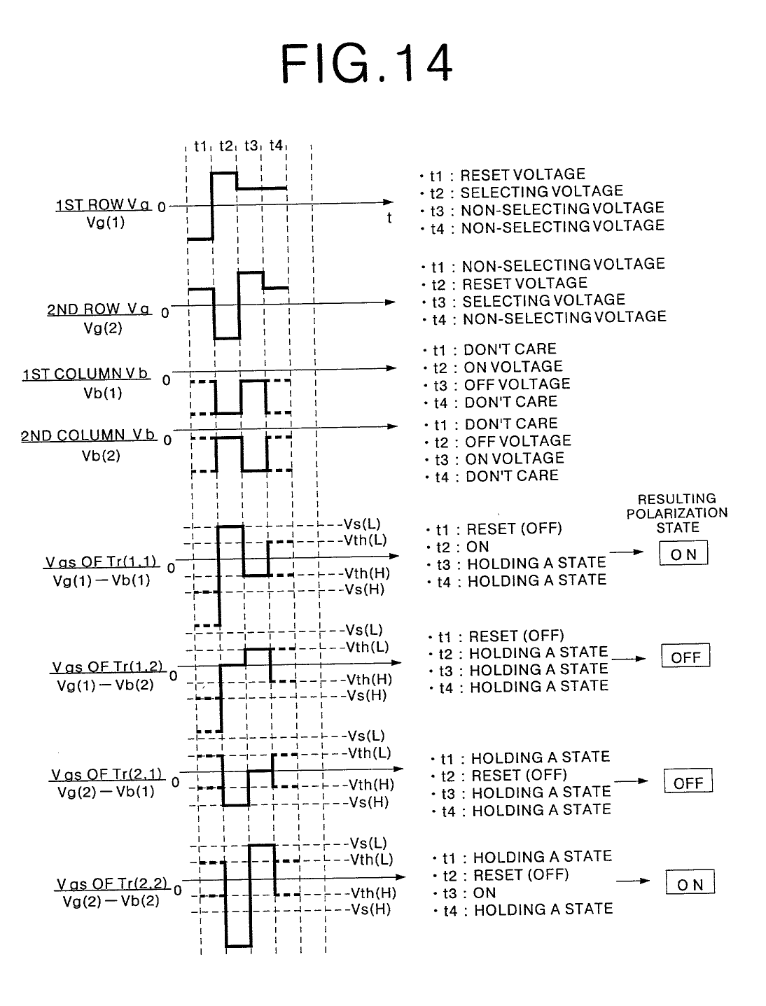

Next, the data writing method will be described in reference to FIGS. 13 and 14. Assume that in a 2×2 matrix circuit such as that shown in FIG. 13, the following data are written in.

Tr(1.1)→ON Tr(1,2)→OFF

Tr(2,1)→OFF Tr(2.2)→ON

In the constitution shown in FIG. 13, if a predetermined voltage is applied to the FETs (Tr(1.1) to Tr(2,2)) so that the voltage waveforms shown in FIG. 14 are obtained, then desired data will be written to each FET in order of a row and the polarization state of each FET will be stored in memory.

Therefore, if a waveform such as that shown in FIG. 14 is applied to each electrode, it will become possible to write data to all pixels at high speed. For example, when data is written to a 1000-row matrix for 1 μs per row, the data writing to all pixels is completed in 1 ms.

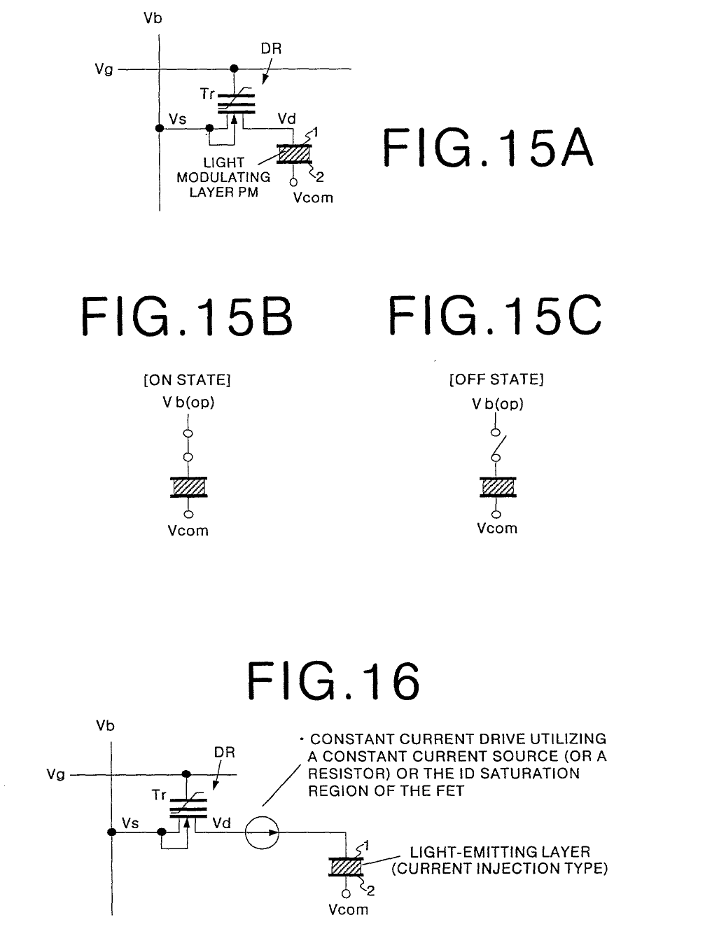

As previously described, if the voltage range of V_{gs} is between V_{gs(L)} and V_{gs(H)} of FIG. 6 after the change in the gate polarization state of the ferroelectric gate FET, a switching operation between conducting and non-conducting will become possible according to written data. FIG. 15 shows an equivalent circuit diagram used to explain the switching operation of the ferroelectric gate FET. FIG. 15(B) shows the FET of FIG. 15(A) being in an ON state, while FIG. 15(C) shows the FET being in an OFF state.

Now, in the case where V_{b(op)} has a predetermined voltage with respect to V_{com}, if V_{b(op)} is applied to V_{b} in common for all pixels and if voltage is applied to V_{g} so that V_{b(op)}+V_{gs(L)}≦V_{g}≦V_{b(op)}+V_{gs(H)}, then V_{gs} (=V_{g}−V_{b}) will satisfy V_{gs(L)}≦V_{g}≦V_{gs(H)} at all times and written data will not change. At this time, the voltage on the light modulating layer PM connected to the FET in the ON state is nearly V_{b(op)} and therefore the light modulating layer PM is caused to be in a modulating state. On the other hand, the voltage on the light modulating layer PM connected to the FET in the OFF state is nearly zero and therefore the light modulating layer PM is caused to be in a non-modulating state.

In the example shown in FIG. 15, the ferroelectric gate FET operates as a simple switching device; however, if the light modulating layer PM is replaced with a light-emitting layer and the FET is driven with a constant current, then current injection types, such as LEDs, organic ELs, FEDs, electronic devices, etc., can be driven (see FIG. 16). That is, two-dimensional active-matrix LEDs, organic ELs, FEDs, and electronic devices can be constituted by a pixel circuit such as that shown in FIG. 16.

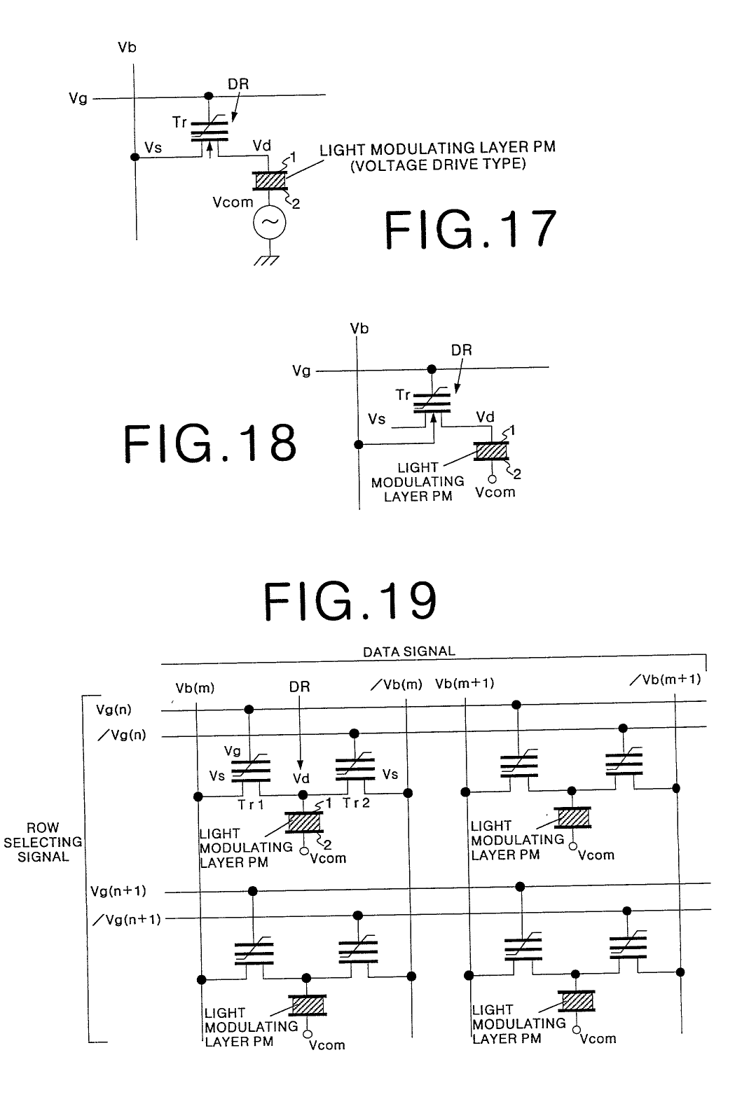

In addition, if AC voltage V_{ac} is applied between V_{b(on)} and V_{com}then liquid crystals and thin-film ELs can be driven with a constant voltage. That is, a liquid crystal and a thin-film EL of a two-dimensional active-matrix type can be constituted by a pixel circuit such as that shown in FIG. 17.

While the aforementioned embodiment has been described with reference to the two-dimensional active-matrix type light modulation and light-emitting devices in which the substrate electrode or back-surface electrode (in the channel region) of the ferroelectric gate FET is connected to the source electrode, the light modulation and light-emitting devices according to the present invention are not limited to the aforementioned embodiment.

For example, the source electrode may be in a floating state, and the n-channel ferroelectric gate FET may be replaced with a p-channel ferroelectric gate FET.

Also, by connecting the substrate electrode (or the back-surface electrode) to the data signal line, the same data writing as the above-mentioned description may be performed. In this case, after data has been written in, the light modulating layer PM is driven by the voltage on the source electrode Vₛ (see FIG. 18). In addition, during writing, the source electrode may be in a floating state.

Furthermore, the ferroelectric gate FET may be formed on a crystal semiconductor substrate or it may be formed on an insulating substrate as a thin film.

In the above-mentioned description, although it has been described that a single ferroelectric gate FET is used as an active-matrix circuit, the light modulation and light-emitting devices according to the present invention can also use a plurality of ferroelectric gate FETs (at least two ferroelectric gate FETs) to constitute two-dimensional active-matrix type light modulation and light-emitting devices.

The constitution and drive method of a two-dimensional active-matrix type light modulation device employing two ferroelectric gate FETs in each pixel circuit will hereinafter be described in reference to FIGS. 19 through 21.

FIG. 19 shows an equivalent circuit of a portion of a two-dimensional active-matrix type light modulation device employing two ferroelectric gate FETs. In the figure, there are shown the pixel circuits constituted by the mth column, (m+1)st column, nth row, and (n+1)st row of the two-dimensional matrix light modulation device consisting of a plurality of pixels. Each pixel circuit is constituted by first and second ferroelectric gate FETs (Tr1 and Tr2) where the respective drains are connected with each other, a light modulating layer PM, etc.

The source electrodes of the first ferroelectric gate FETs (Tr1) in the same column are connected together and data signal V_{b(m)} or V_{b(m+1)} is input in a column unit. Likewise, the source electrodes of the second ferroelectric gate FETs (Tr2) In the same column are connected together and the data signal V_{b(m)} or V_{b(m+1)} is input in a column unit. Also, the gate electrodes of the first ferroelectric gate FETs (Tr1) in the same row are interconnected and row selecting signal V_{g(n)} or V_{g(n+1)} is input in a row unit. Furthermore, the gate electrodes of the second ferroelectric gate FETS (Tr2) in the same row are interconnected and the row selecting signal V_{g(n)} or V_{g(n+1)} is input in a row unit. The pixel electrode 1 of each pixel is connected to the drains of the first and second ferroelectric gate FETs (Tr1 and Tr2), and voltage V_{com} is applied to the counter electrode 2. A description will hereinafter be made of the drive method in this constitution.

Initially the data writing method will be described. First, “ON” data or “OFF” data is written in order of a row. Then, row selection is performed with V_{g(※)} and /V_{g(※)} (where V_{g(※)} and /V_{g(※)} are assumed to be the same voltage and ※ denotes a row number). Furthermore, data writing is performed with V_{b(※)} and /V_{b(※)} (where V_{b(※)} and /V_{b(※)} are assumed to be complementary signals and ※ denotes a column number).

The embodiment shown in FIG. 19 is substantially identical in construction and operation with the embodiment shown in FIG. 7 except that one ferroelectric gate FET is replaced with two ferroelectric gate FETs. Considering that V_{g(⊃)} and /V_{g(※)} are the same voltage and that V_{b(※)} and /V_{b(※)} are complementary signals, the data writing method can be carried out according to FIGS. 8 through 12 and Table 1 and therefore a description thereof will not be given.

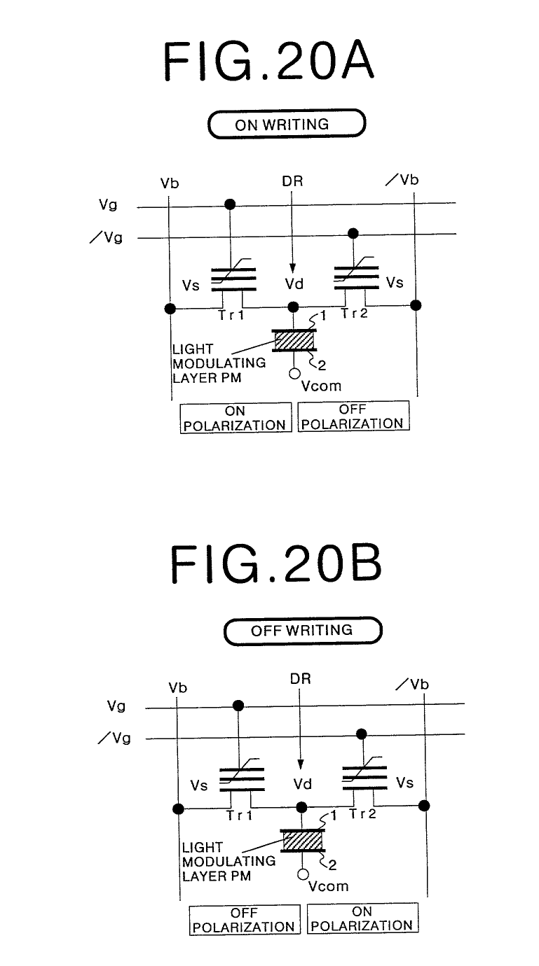

FIG. 20 shows the polarization state of the ferroelectric gate FET of a certain pixel circuit obtained during data writing. FIG. 20(A) shows the ON writing state, while FIG. 20(B) shows the OFF writing state. As clearly seen from these figures, in the case of ON writing, the polarization of the first ferroelectric gate FET (Tr1) is caused to be in an ON state, while the polarization of the second ferroelectric gate FET (Tr2) is caused to be in an OFF state. On the other hand, in the case of OFF writing, the polarization of the first ferroelectric gate FET (Tr1) is caused to be in an OFF state, while the polarization of the second ferroelectric gate FET (Tr2) is caused to be in an ON state.

Next, a method of driving the light modulating layer PM will be described in reference to FIG. 21.

After data has been written to all pixels, the light modulating layer PM is driven in the following manner (see FIG. 21(A)). Note that in the following equations, subscripts representing rows and columns are omitted.

Rectangular waveform voltages with a Vh level and a Vl level arc applied to V_{b} in common for all pixels.

A rectangular waveform voltage with the opposite phase of V_{b} is applied to /V_{b} in common for all pixels.

The same rectangular waveform voltage as /V_{b} is applied to V_{com} in common for all pixels.

Furthermore, a voltage of (V_{b}+V_{gs(L)}≦V_{g}≦V_{b}+V_{gs(H)}) for holding a polarization state is applied to /V_{g} in common for all pixels.

A voltage of (/V_{b}+V_{gs(L)}≦V_{g}≦/V_{b}+V_{gs(H)}) for holding a polarization state is applied to /V_{g} in common for all pixels.

Note that the voltage waveforms of V_{b}, /V_{b}, V_{com}, V_{g}, and /V_{g} in the above-mentioned drive example are shown in FIG. 21(A).

By applying voltage in the aforementioned manner, the drain voltage on each pixel is obtained as shown in FIG. 21(B), and the voltage on the light modulating layer PM of each pixel is obtained as shown in FIG. 21(C).

Thus, it is possible to constitute a two-dimensional active-matrix type light modulation device by using two ferroelectric gate FETs. Even in this constitution, the number of transistors is reduced as compared with a conventional device using a SRAM circuit (which includes 6 to 8 transistors). It is also possible to perform stable static drive as in SRAM circuits. Furthermore, since AC drive is possible, a two-dimensional active-matrix type liquid crystal and a two-dimensional active-matrix type thin-film EL (light modulation device) can be constituted. In the case of AC drive, the voltage on the light modulating layer PM is about twice AC drive voltage with respect to the power supply, as shown in FIG. 21(C). Therefore, it becomes possible to the light modulating layer with a power supply which is about half the voltage required for driving the light modulating layer PM, so that the device size and cost can be reduced.

Note that of course, by replacing the light modulating layer PM with a light-emitting layer, it is possible to constitute a two-dimensional active-matrix type light-emitting device by using two ferroelectric gate FETs.

While the present invention has been described with reference to preferred embodiments thereof, the invention is not to be limited to the details given herein, but may be modified within the scope of the appended claims.

What is claimed is:

1. A two-dimensional active-matrix type light modulation device comprising:
a plurality of pixel electrodes arranged in the form of a two-dimensional matrix consisting of rows and columns;
a plurality of counter electrodes;
a plurality of light modulating layers, each light modulating layer being interposed between said pixel electrode and said counter electrode for modulating light incident thereon in accordance with an applied voltage between said pixel electrode and said counter electrode; and
a drive circuit constituted by ferroelectric gate field-effect transistors respectively connected to said pixel electrodes.

2. The two-dimensional active-matrix type light modulation device as set forth in claim 1, wherein said drive circuit writes data to said ferroelectric gate field-effect transistors in order of a row.

3. The two-dimensional active-matrix type light modulation device as set forth in claim 1 or 2, wherein said drive circuit writes data to all of said pixels and then applies a voltage for driving said light modulating layer between said counter electrode and said pixel electrode in common for all pixels.

4. The two-dimensional active-matrix type light modulation device as set forth in any one of claims 1 through 3, wherein said drive circuit changes a ferroelectric gate of said ferroelectric gate field-effect transistor to a first polarization state and then writes data in accordance with input of data so that said first polarization state is changed to a second polarization state or so that said first polarization state is held.

5. The two-dimensional active-matrix type light modulation device as set forth in any one of claims 1 through 4, wherein said drive circuit performs row selection with a gate electrode of said ferroelectric gate field-effect transistor and writes data with a source electrode and drain electrode of said ferroelectric gate field-effect transistor and a substrate electrode or back-surface electrode of said ferroelectric gate field-effect transistor.

6. The two-dimensional active-matrix type light modulation device as set forth in any one of claims 1 through 5, wherein said drive circuit performs modulation by binary static drive.

7. A two-dimensional active-matrix type light-emitting device comprising:
a plurality of pixel electrodes arranged in the form of a two-dimensional matrix consisting of rows and columns;
a plurality of counter electrodes:
a plurality of light-emitting layers, each light-emitting layer being interposed between said pixel electrode and said counter electrode for emitting light in accordance with current flowing through the light-emitting layer between said pixel electrode and said counter electrode; and
a drive circuit constituted by ferroelectric gate field-effect transistors respectively connected to said pixel electrodes.

8. The two-dimensional active-matrix type light-emitting device as set forth in claim 7, wherein said drive circuit writes data to said ferroelectric gate field-effect transistors in order of a row.

9. The two-dimensional active-matrix type light-emitting device as set forth in claim 7 or 8, wherein said drive circuit writes data to all of said pixels and then allows a current for driving said light-emitting layer to pass through said counter electrode and said pixel electrode in common for all pixels.

10. The two-dimensional active-matrix type light-emitting device as set forth In any one of claims 7 through 9, wherein said drive circuit changes a ferroelectric gate of said ferroelectric gate field-effect transistor to a first polarization state and then writes data in accordance with input of data so that said first polarization state is changed to a second polarization state or so that said first polarization state is held.

11. The two-dimensional active-matrix type light-emitting device as set forth in any one of claims 7 through 10, wherein said drive circuit performs row selection with a gate electrode of said ferroelectric gate field-effect transistor and writes data with a source electrode and drain electrode of said ferroelectric gate field-effect transistor and a substrate electrode or back-surface electrode of said ferroelectric gate field-effect transistor.
